(19) United States
(12) Patent Application Publication
(10) Pub. No.: US 2017/0305212 A1
(43) Pub. Date: Oct. 26, 2017

(54) Method and System for Tire Pressure Monitoring System (TPMS) with Time Encoded Wireless Tire Condition Sensing Device and Synchronization

(71) Applicant: Chung I Lin, Tainan CIty (TW)

(72) Inventor: Chung I Lin, Tainan CIty (TW)

(21) Appl. No.: 14/535,325

(22) Filed: Nov. 7, 2014

(30) Foreign Application Priority Data
Sep. 18, 2014 (TW) 103132274

(51) Int. Cl. B60C 23/04

(52) U.S. Cl. CPC B60C 23/0442; B60C 23/0488; B60C 23/0415; B60C 23/0464

(57) ABSTRACT

The present invention disclosed herein is a tire pressure monitoring system (TPMS) with a time encoded wireless tire condition sensing device and synchronization in which each transmitter ID is assigned its own timing parameter through the controlling device wherein each timing parameter has a different time delay to prevent any launch time transmission overlap and the main controller can function to sync the transmitters to prevent or correct any clock rate or clock frequency errors generated by the transmitters.

### INCORPORATION BY REFERENCE

This application claims the benefit of priority under 35 U.S.C. 119 to a Republic of China (Taiwan) application No. 103132274, filed on Sep. 18, 2014, the disclosure of which is incorporated herein by reference in its entirety.

### FIELD OF INVENTION

The present invention related to a tire pressure monitoring system (TPMS), and more particularly to a tire pressure monitoring system (TPMS) with a time encoded wireless tire condition sensing device and synchronization.

### BACKGROUND

Motor vehicles are undoubtedly one of the most important transportation to modern society, and therefore safety issue regarding motor vehicles has become a major concern. For ensuring driving safety, tire air pressure, especially, plays an important factor of road safety. Improper tire pressure can lead to greater fuel consumption and inferior vehicle controllability, which threatens the safety of the drivers and the passengers. When the tire pressure is too low, the friction between the road and the tire increases, which may result in drivers losing control of the vehicle. Under low tire pressure, the tire may roll out of the tire rim resulting in serious accidents. When the tire pressure is too high, the friction reduces, which may lead to skidding and out of control. In addition, the high-pressure tire is more prone to burst when its temperature increases through traveling.

Therefore, there exists prior art in the current market, which will allow driver to check the tire pressure before traveling to make sure the tire pressure is in a safe range. However, it is inconvenient when the driver has to manually check the tire pressure every single time. To resolve this issue, the current practice is to install a pressure detector on the tires to constantly gather and report to the driver. When installing such detector, manufactures use a bolt and a gas nozzle to fix the detector inside the tire frame. While driving, the detector in each tire will send tire conditions such as pressure back to the central controller for the driver to review. This system is generally referred to as the tire pressure monitor system (TPMS).

A tire pressure monitoring system (TPMS) is an electronic system that is designed to monitor and provide real-time information of the air pressure of tires on various types of vehicles. The accurate measure of vehicle tire pressure while a vehicle is moving can prevent accidents and increase gas mileage. Government and university studies have cited the connection between tire under-inflation and vehicle crashes, including fatality rates. Furthermore, The accurate measure of vehicle tire pressure can increase the fuel efficiency of vehicles through reducing rolling resistance of the vehicles.

Generally, TPMS report the tire air pressure information via a gauge, a pictorgram display, or a simple low-pressure warning light. Furthermore, TPMS in use today are primarily either direct or indirect systems. Direct systems use a pressure sensor, either internally or externally, on each of the tires to directly measure tire pressure. Indirect systems use the ABS to derive the tire pressure by comparing the number of revolutions of each wheel while driving. The circumference of a tire with low pressure is slightly less than one with correct pressure. Therefore, the revolutions per mile of the low pressure wheel is greater and these increased revolutions can be used to detect a low tire pressure.

Indirect tire pressure systems have great appeal because they can be combined with an existing ABS. The ABS already measures the rotation of each wheel so adding an ABS based TPMS only involves modifying the ABS software and adding a warning light display to the instrument cluster.

Unfortunately, ABS indirect systems are very inaccurate. Since the decrease in circumference of tires with low pressure is very slight, a large pressure drop combined with a long driving distance must occur to trigger a low tire pressure warning. Also, if the pressure is simultaneously low in all four tires on an vehicle, no detection is possible because there is no differential wheel rotations to detect.

The performance of a direct TPMS is far superior. Since tire pressure is being measured directly, low pressure warnings can be made instantly and very accurately. Although more accurate, direct systems are much more expensive than indirect systems because new hardware must be added to the vehicle.

Moreover, essentially all modern direct TPMS are wireless systems. A pressure sensor and transmitter is placed inside the tire (typically mounted on the rim) and a receiver is mounted elsewhere on the vehicle. Most wireless systems operate at a frequency of 433 MHz or higher to obtain a large transmission range. Most systems also require a new stand-alone receiver although a few systems share the keyless entry system receiver that is installed on some luxury or higher tier vehicles.

Furthermore, after the tire pressure sensors are installed on each tire and have been in operation for some time, they may have clock rate or clock frequency errors, which will result in overlapping signals. When the main controller receives such overlapping signals, it will interfere with the calculation and resulting in erroneous information being provided to the driver.

The current wireless tire pressure detectors, such as ROC Patent Publication No. 201,314,187 “wireless tire pressure sensors to avoid duplication of data transfer method”, mainly assigns each set of the wireless tire pressure sensors its own ID and a set of different wake-up-time parameters. When the wireless tire pressure sensor starts working, it first identifies the ID and uses the corresponding algorithm to calculate which wake-up-time parameter to select, and send the data after the wake up time ends. The reason for assigning different wake-up-time to each sensors is to avoid overlapping data at the receiver, which may cause missed or false information. In addition to the different wake-up-time for each wireless tire pressure sensor to transfer data, each sensor is also assigned different spacing time to avoid overlapping at the receiver.

Unfortunately, such wireless tire pressure detectors use manual tire pressure detectors that require drivers to check the detectors every time before driving the vehicle. Furthermore, since it uses different ID, wake-up-time and corresponding algorithm to avoid data overlapping at the receiver, each individual algorithm and wake-up-time will interfere with each other while functioning. As a result, the central controller cannot distinguish among the received information. Finally, after the tire pressure sensors are installed on each tire and have been in operation for some time, they may have clock rate or clock frequency errors, which will result in overlapping signals. When the main controller receives such overlapping signals, it will interfere with the calculation and resulting in erroneous information being provided to the driver.

Accordingly, in order to resolve the inconveniences arising from detecting tire pressure manually and to eliminate errors arising from overlapping data as a result of overlapping receiving time from different ID and algorithm of various wireless tire pressure sensors, the present invention develops a Method and System for Tire Pressure Monitoring System (TPMS) with Time Encoded Wireless Tire Condition Sensing Device wherein the device detects each and every single sensor through one central system and multiple transmitters.

### OBJECTIVE OF THE INVENTION

Accordingly, it is the object of this invention to provide a method and system for a tire pressure monitoring system wherein main controller can communicate with one or more tire sensors.

It is also the object of this invention to provide a method and system for a tire pressure monitoring system wherein the main controller and the sensors can communicate wirelessly.

It is also the object of this invention to provide a method and system for a tire pressure monitoring system wherein the main controller and the sensors are synced with a time parameter to prevent signal interference.

It is also the object of this invention to provide a method and system for a tire pressure monitoring system wherein there is a synchronization function to prevent clock rate or clock frequency errors.

It is also the object of this invention to provide a method and system for a tire pressure monitoring system wherein the tire sensor can detect tire condition, such as tire pressure data, temperature data, centrifugal force data and battery voltage information.

It is also the object of this invention to provide a method and system for a tire pressure monitoring system wherein the main controller can display the condition on the display unit in the vehicle for the driver to review in the driver's convenient time.

It is also the object of this invention to provide a method and system for a tire pressure monitoring system such that it is simple to replace the tires, wherein the driver only needs to press the button on the new transmitter, and then the main controller will replace the old transmitter. The main controller's second micro-processing unit will match the old time parameter to the new transmitter, so the new transmitter will function immediately.

It is also the object of this invention to provide a method and system for a tire pressure monitoring system that is relatively inexpensive to manufacture, easily adoptable to current vehicles or tires, and is effective and efficient.

### SUMMARY OF THE INVENTION

As aspect of the invention is disclosed, specifically, a method for monitoring tire pressure which comprises: providing a main controller wherein the main controller is comprised of a second micro processing unit, a second memory unit, a first receiver unit , a second transmitting unit, a display unit; providing one or more tire transmitter wherein the tire transmitter is comprised of a first micro processing unit, a first memory unit, an operation unit, a detection unit, a first transmitter unit and a second receiving unit; having the first micro processing unit transmit a pairing signal via the first transmitting unit to the second micro processing unit via the first receiver unit; performing a matching process on the pairing signal wherein the matching process is comprised of assigning a first time interval to the pairing signal; storing the pairing signal to the second memory unit; transmitting the pairing signal back to the first micro processing unit via the second transmitting unit and the second receiver unit and storing the pairing signal to the first memory unit; obtaining at least one data point of a tire by the detection unit; transmitting the data point by the first micro processing unit via the first transmitting unit to the second micro processing unit via the first receiver unit at the first time interval; synchronizing the main controller and the one or more tire transmitter comprising the second micro processing unit sending a synchronizing signal via the second transmitting unit and the second receiving unit to the first micro processing unit.

In one embodiment, the first micro processing unit transmits a pairing signal to the second micro processing unit and perform the matching service after receiving the synchronizing signal. In one embodiment, the matching process is comprised of assigning a second time interval.

In one embodiment, after receiving the synchronizing signal the first micro processor proceeds to obtain at least one data point of the tire by the detection unit and transmit the data point by the first micro processing unit via the first transmitting unit to the second micro processing unit via the first receiver unit at the first time interval.

In one embodiment, the first transmitter unit, the first receiver unit, the second transmitter unit and the second receiver unit are comprised of radio frequency technology. In one embodiment, the first radio transmitter unit is a low frequency transmitter unit and the second radio receiver unit is a high frequency radio receiver unit. In one embodiment, the first radio receiver unit is a low frequency receiver unit and the second radio transmitter unit is a high frequency radio transmitter unit. In one embodiment, the first radio transmitter unit is a high frequency transmitter unit and the second radio receiver unit is a low frequency radio receiver unit. In one embodiment, the first radio receiver unit is a high frequency receiver unit and the second radio transmitter unit is a low frequency radio transmitter unit. In one embodiment, the first transmitter unit, the first receiver unit, the second transmitter unit and the second receiver unit are comprised of infra red communication technology. In one embodiment, the first transmitter unit, the first receiver unit, the second transmitter unit and the second receiver unit are comprised of bluetooth communication technology. In one embodiment, the paring signal is comprised of an identification code to identify the transmitter.

### BRIEF DESCRIPTIONS OF THE DRAWINGS

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 is a schematic diagram illustrating a main controller and four transmitters on the wheels of the vehicle.

FIG. 2 is a schematic diagram illustrating the interaction between a main controller and a transmitter.

FIG. 3 is a schematic diagram illustrating the interaction between a main controller and a transmitter using an alternative embodiment of the present invention.

FIG. 4 is a schematic flow chart illustrating the tire pressure monitoring system (TPMS) with time encoded wireless tire condition sensing device.

FIG. 5 is a schematic flow chart illustrating the pairing process of the present invention.

FIG. 6 is a schematic chart illustrating the timing of the present invention.

FIG. 7 is a schematic chart illustrating the replacement of an old transmitter, and the use of timing parameters.

FIG. 8 is a schematic flow chart illustrating the operating system of the present invention

FIG. 9 is a schematic diagram illustrating the use status of the present invention.

FIG. 10 is a schematic diagram illustrating the use status of the present invention.

FIG. 11 illustrates a main controller that displays the condition of the four tires of a vehicle where the tires are operable.

FIG. 12 illustrates a main controller that displays the condition of the four tires of a vehicle where the right front tire of the vehicle is flagged.

### DETAILED DESCRIPTIONS OF THE INVENTION

The invention disclose herein provides for a method and system for a tire pressure monitoring system (TPMS) with time encoded wireless tire condition sensing device and synchronization in order to resolve the inconveniences arising from detecting tire pressure manually and to eliminate errors from overlapping data receiving time through the different ID and algorithm of wireless tire pressure sensors. Such device detects each and every single sensor through one central system and multiple transmitters.

Specifically, each one of the tires corresponds to a transmitter with a unique serial number and a first micro-processing unit with a memory unit. Electrically connected to the first micro-processing unit are (1) a first operation unit, (2) a detecting unit, (3) a high frequency transmitter unit, and (4) a low frequency receiver unit.

On the other hand, a main controller with a second micro-processing unit with a second memory unit is installed inside the vehicle. Electronically connected to the second micro-processing unit are (1) a second operation unit, (2) a high frequency receiver unit, (3) a low frequency transmitter unit, and (4) a display unit.

Initially, the operation unit will have the first micro-processing unit send out a pairing signal. The pairing signal is sent out from the high frequency transmitter unit and received by the high frequency receiver unit. The high frequency receiver unit, then, transmit the pairing signal to the second micro-processing unit for time pairing program. The time pairing program provides each transmitter a corresponding, but unique time parameter, and each time parameter is assigned a different delay time, and the time parameter is stored in the second memory unit.

Furthermore, the main controller will, at a set time or interval, perform a synchronization between the main controller and the transmitters. Specifically, the second micro-processing will send out a synchronization signal, which is stored in the second memory unit, via a low frequency transmitter. The low frequency receiver receives the synchronization signal, which is then stored in the first memory unit.

Then, according to the time parameter of each transmitter, the synchronization signal will delay the time interval to ensure that the transmitters are in sync and the time parameters are being conserved. Thereafter, the tire information will be sent via the high frequency transmitter and received by the high frequency receiver, and be stored in the second micro-processor for display by the display unit.

At the same time, the time parameter will be sent through the low frequency radio transmitter and received through the low frequency radio receiver and stored in the second micro-processing unit for the display unit to display the data to the driver.

The timing parameter is 1˜N, where N is a natural number, which is the delay time. The operating unit can be a button. Furthermore, the tire condition includes any of the following or a combination of the followings: a tire pressure data, a temperature data, a centrifugal force data, a battery voltage data.

The present invention of time encoding wireless sensing device for tire condition has the actual time encoding function. First, the operation unit will have the first micro-processing unit sent out a pairing signal. The pairing signal is sent out from the radio frequency transmitter unit and received by the radio frequency receiver unit. The radio frequency receiver unit, then, transmit the paring signal to the Second micro-processing unit for time pairing program. The time paring program provides each transmitter a corresponding, but unique time parameter. The timing parameter is 1˜N, where N is a natural number. Each time parameter has a different delay time to mainly avoid the signal interference and overlapping problem.

The present invention's operating unit can also be installed on the main controller. The operation unit will have the second micro-processing unit to send out “wake-up” signal. The “wake-up” signal is transmitted from the low frequency radio transmitter unit to the low frequency radio receiver unit. Then the “wake-up” signal will run through the time pairing program, which will match each transmitter's ID with its own time parameter. Each time parameter will have a different delay time to mainly avoid the signal interference and overlapping problem.

The present invention will also perform a synchronization between the main controller and the transmitters. Specifically, the second micro-processing will send out a synchronization signal, which is stored in the second memory unit, via a low frequency transmitter. The low frequency receiver receives the synchronization signal, which is then stored in the first memory unit.

Then, according to the time parameter of each transmitter, the synchronization signal will delay the time interval to ensure that the transmitters are in sync and the time parameters are being conserved. Thereafter, the tire information will be sent via the high frequency transmitter and received by the high frequency receiver, and be stored in the second micro-processor for display by the display unit. This effectively prevents clock rate or clock frequency errors as a result of signal overlap, and therefore, allows the main controller to accurate receive the signals emitted by each of the transmitters.

The present invention installs each transmitter on different tires, so it can detect tire condition, such as tire pressure data, temperature data, centrifugal force data and battery voltage information, and display the condition on the display unit in the vehicle for the driver to review in the driver's convenient time.

The present invention has a simple method for replacing tires. The driver only needs to press the button on the new transmitter, and then the main controller will replace the old transmitter. The main controller's second micro-processing unit will match the old time parameter to the new transmitter, so the new transmitter will function immediately.

### DETAILED DESCRIPTIONS OF THE DRAWINGS

The present invention relates to a sequence encoding functions of a tire information wireless sensing devices and methods. The main technical characteristics , purpose and effectiveness will be clearly presented to the embodiments described below .
(1) Transmitter
(101) a first micro-processing unit
(1011) a first memory unit
(102) the operating unit
(103) Detection unit
(104) radio frequency transmitter unit
(105) the low frequency radio receiver unit
(11) a first transmitter
(12) a second transmitter
(13) third transmitter
(14) The fourth transmitter
(2) the main controller
(201) a second micro-processing unit
(2011) second memory unit
(202) radio frequency receiver unit
(203) the low-frequency wireless transmitting unit
(204) the operating unit
(205) display unit
(21) Screen

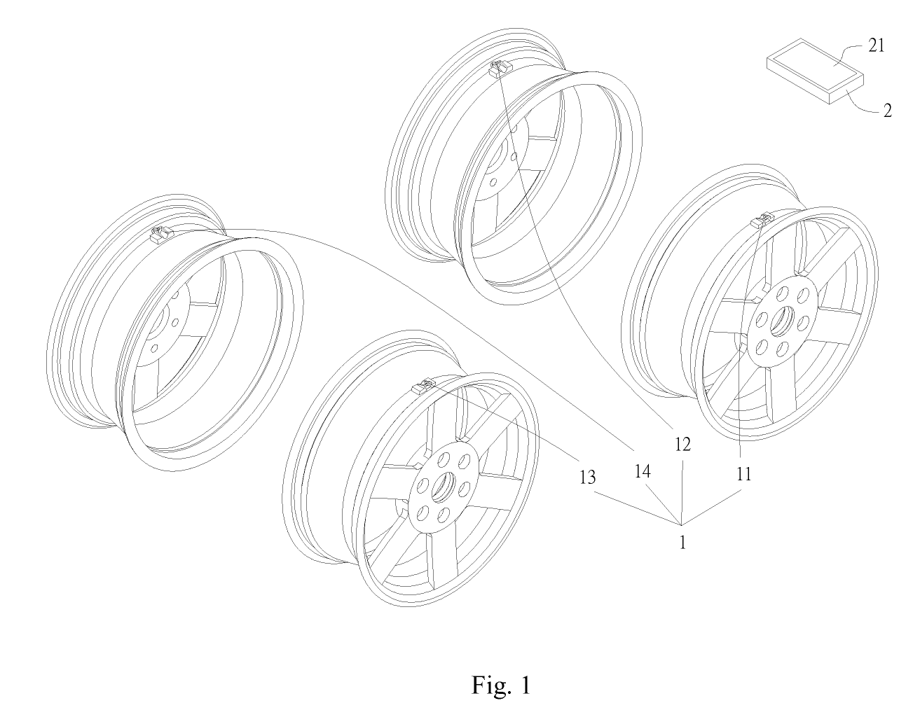

Referring to FIG. 1, the present invention discloses a method and system for a tire pressure monitoring system with time encoded wireless tire condition sensing device and synchronization to monitor tire conditions. The present invention comprises several transmitters (1) and a master controller (2). In the present embodiment, the main controller (2) can be mounted on a car (not shown). The main controller (2) also includes a display screen (21). There are four transmitters (1) that corresponds to the four tires of the vehicle. The four transmitters (1) are as follows: a first transmitter (11) is mounted on the front wheel of the right hand side. A second transmitter (12) is mounted on the front of the wheel on the left hand side. A third transmitter (13) is mounted on the back wheel of the right hand side. And a fourth transmitter (14) is mounted on the back wheel of the left hand side. In the factory, the first transmitter (11) is set with an ID number 1. And the second transmitter (12) is set with an ID number 2. The third transmitter (13) is set with an ID number 3. The fourth transmitter (14) is set with an ID number of number 4. And the first transmitter (11), the second transmitter (12), the third transmitter (13) and the fourth transmitter (14) detect their corresponding tires. a method and system for tire pressure monitoring system with time encoded wireless tire condition sensing device monitor tire pressure data, temperature data, centrifugal force data, and battery voltage information.

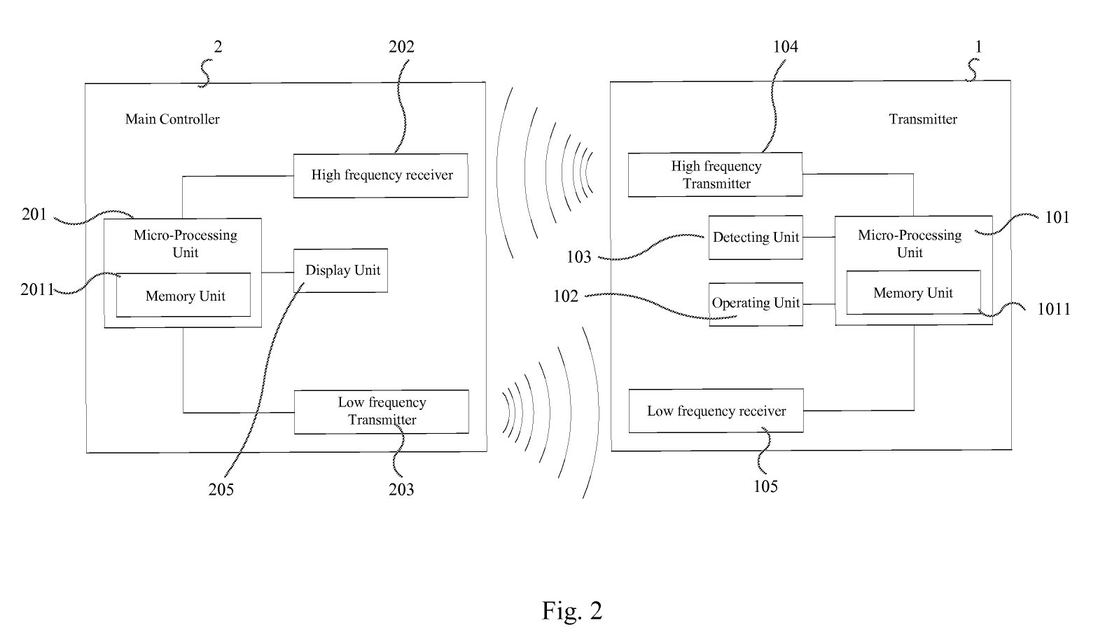

Referring to FIG. 2, the transmitter (1) is located in the detection end of the device (i.e., the tire), and the main controller (2) is located in the controlling end (i.e., the vehicle).

The transmitter (1) comprises: a first micro-processing unit (101) and includes a first memory unit (1011); an operation unit (102) electrically connecting the first micro-processing unit (101); a detection unit (103) electrically connecting the first micro-processing unit (101) for the detection of the tire including the tire information; a radio frequency transmitter unit (104), electrically connecting the first micro-processing unit (101); and a low-frequency radio receiving unit (105) electrically connecting the first micro-processing unit (101).

The master controller (2) includes: a second micro-processing unit (201) and includes a second memory means (2011); a radio frequency receiver unit (202) electrically connected to the second micro-processing unit (201); a high-frequency wireless transmitting unit (104); a low-frequency radio transmitting unit (203) electrically connected to the second micro-processing unit (201); a receiving unit should be a low frequency radio (105); and a display unit (205) electrically connected to the second micro-processing unit (201) .

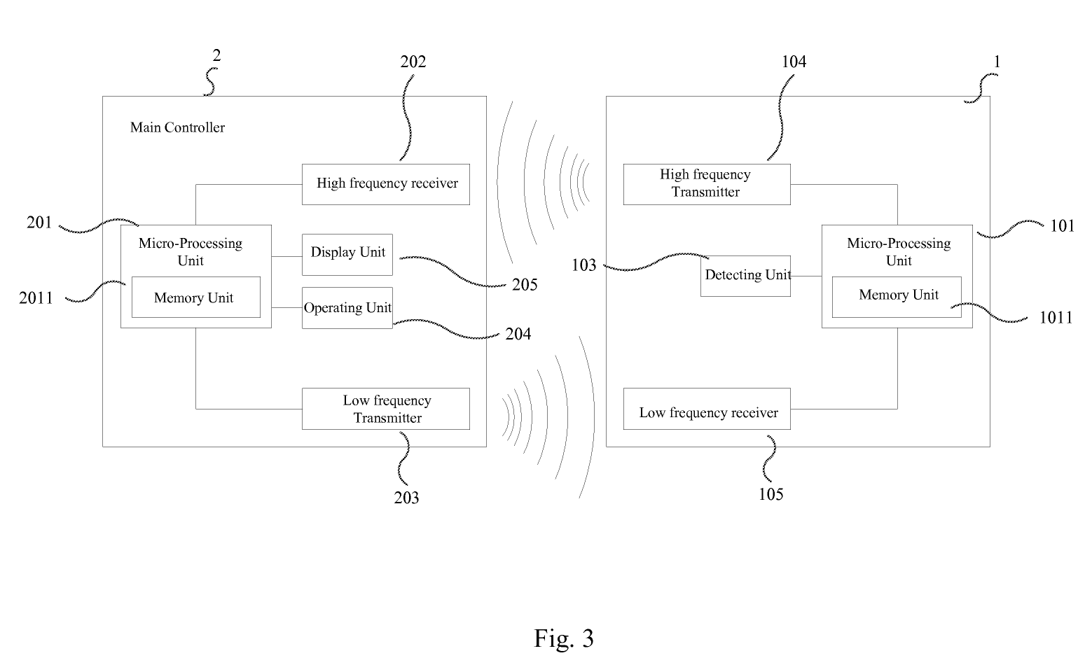

Referring to FIG. 3, the main controller (2) includes the operation unit (204). Further, the operation unit (204) will have the second micro-processing unit (201), including a second memory unit (2011), and is connected to a high frequency receiver (202), a low frequency transmitter (203), and a display unit (205). The main controller (2) will send a “wake-up” signal, which will be emitted by the low-frequency transmitter unit (202), and the transmitter's (1) low-frequency radio receiving unit (105) receives the signal. The low-frequency radio receiving unit (105) will send the “wake-up” signal to the first micro-processing unit (101), which includes a memory unit (1011) and is also connected to a high frequency transmitter (104) and a detecting unit (103).

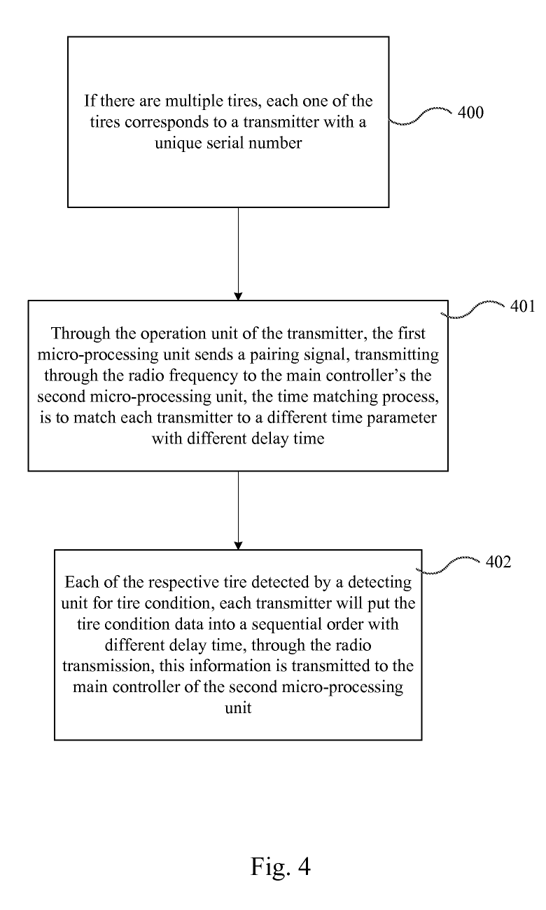

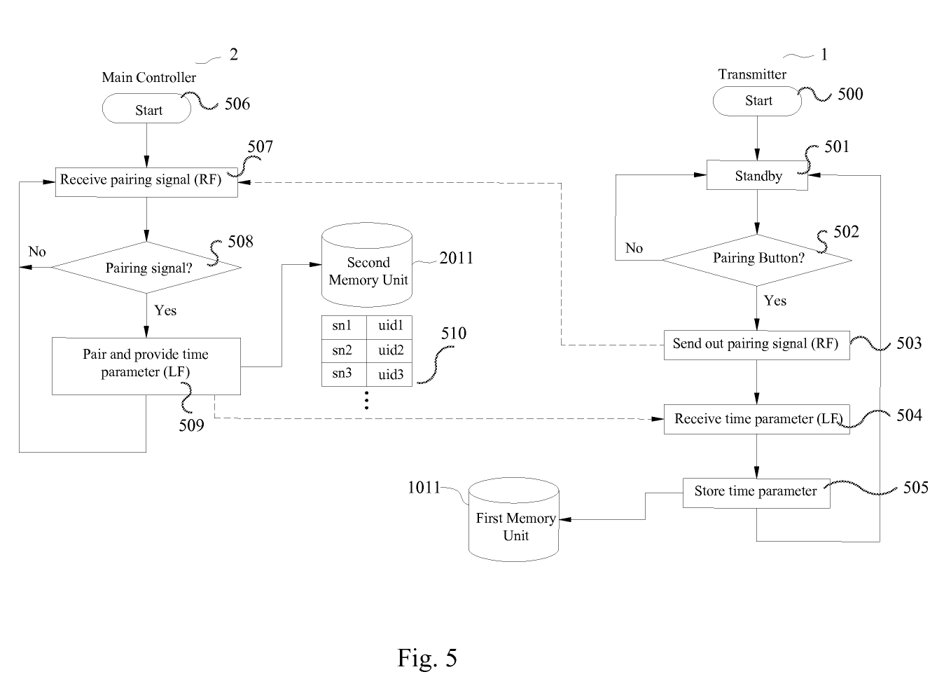

Referring to FIG. 4 in accordance with FIG. 5, the sequencing function of present invention includes the following steps: in the first step (300), each tire has a transmission device (1), and each transmitter (1) is given a sequence number.

In the next step (301), through the operation unit (102) of the transmitter (1), the first micro-processing unit (101) sends a pairing signal, transmitting through the radio frequency to the main controller (2)'s the second micro-processing unit (201). The time matching process is to match each transmitter (1) to a different time parameter with different delay time.

Finally, in the last step (302), each of the respective tire detected by a detecting unit (103) for tire condition, each transmitter (1) will put the tire condition data into a sequential order with different delay time, through the radio transmission, this information is transmitted to the main controller (2) of the second micro-processing unit (201).

Referring to FIG. 5, the transmitter (1) starts (500) and goes into standby mode (501). If the pairing button (502) is not activated, the transmitter (1) goes back into standby mode (501). If the pairing button (502) is activated, the transmitter (1) sends out a pairing signal (503) to the main controller (2). The transmitter (1) will receive a time parameter (504) from the main controller (2), and the time parameter is stored (505) in the first memory unit (1011).

The main controller (2) starts (506) and when it receives a signal (507) from the transmitter (1), it will determine if its a pairing signal (508). If it is not, the main controller (2) will go back into receive pairing signal (507). If it is, the main controller (2) will pair and provide a time parameter (509), which is stored in the second memory unit (2011).

Still referring to FIG. 5 in accordance with FIGS. 2 and 4, in the present embodiment, the operation unit (102) (204) is a button. When each of the transmitter (1) matches with the main controller (2), the user can press the button, and the transmitter's (1) first micro-processing unit (101) (as shown in the FIG. 2) will emit a pairing signal. The signal, sent via the radio frequency transmitter unit (104) (as shown in FIG. 2), will be received by the master controller's (2) radio frequency receiver unit (202). The pairing signal will be transmitted to the main controller's (2) second micro-processing unit (201) (as shown in FIG. 2) and to a time pairing program. The time pairing process will assign each transmitter (1) a corresponding ID number with a unique time parameter and a different delay time. The timing parameters are 1˜N, where N is a natural number. For example, when the main controller's (2) second micro processing unit (201) (as shown in Fig.2) assigns the first transmitter (11) a time parameter of 1, the signal is delayed for one second. When the master controller's (2) second micro processing unit (201) (as shown in FIG. 2) assigns the second transmitter(12) a time parameter of 2, then the signal is delayed two seconds. When the main the controller (2) of the second micro-processing unit (201) (as shown in FIG. 2) assigns the third transmitter (13) the timing parameters of 3, the delay time is three seconds. When the main control's (2) second micro processing unit (201) (as shown in FIG. 2) assigns the fourth transmitter (14) a timing parameter of 4, the delayed time will be four seconds. That is, the bigger the time parameter is, the longer the delay time is. And various timing parameters are stored in the main system controller's (2) second memory unit (2011). Meanwhile , each of the timing parameters of the main system controller (2) of the low-frequency radio transmitting unit (203) (as shown in FIG. 2) transmitted by the transmitter (1) of the low-frequency radio receiving unit (105) (as shown in FIG. 2) received and saved to the transmitter's (1) first memory unit (1011).

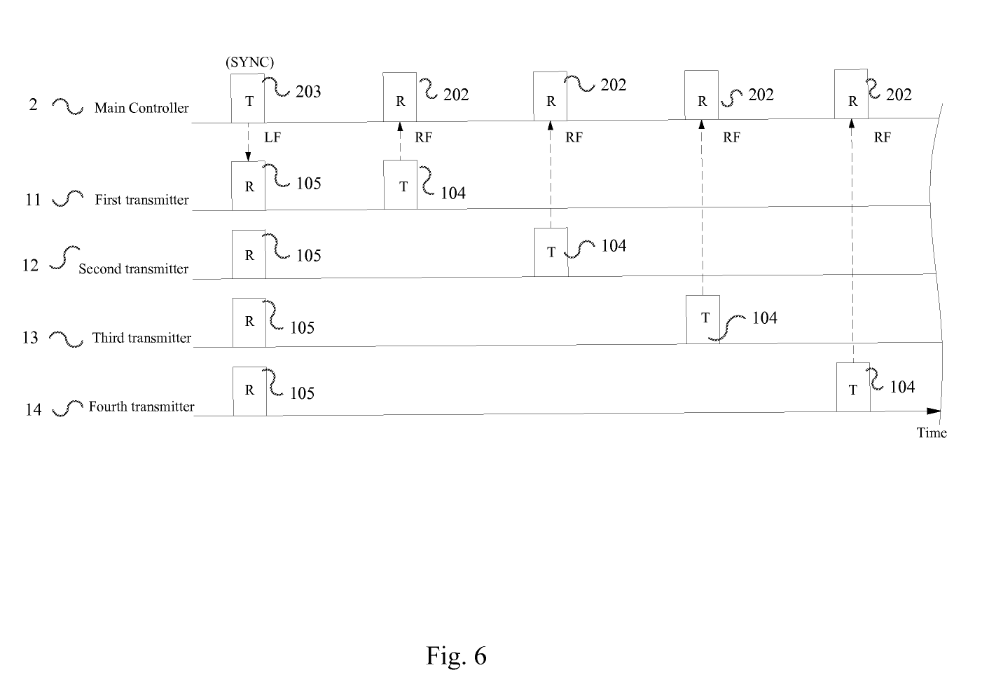

Referring only to FIG. 6, at the beginning , there is no delay between the main controller (2), and the first transmitter (11), the second transmitter (12), the third transmitter (13) and the fourth transmitter (14). By the above setting, one second after the start of operation, the first transmitter (11) will send detecting signal to the main controller (2). Two seconds after the operation, the second transmitter (12) will send detecting signal to the main controller (2). Three seconds after the operation, the third transmitter (13) will send detecting signal to the main controller (2). Four seconds after the operation, the fourth transmitter will send the detecting signal to the main controller (2). Therefore, because the signals are sent at different times, it is effectively avoiding the interferences between transmitters (1), and the main controller (2)'s inability to identify tire condition data.

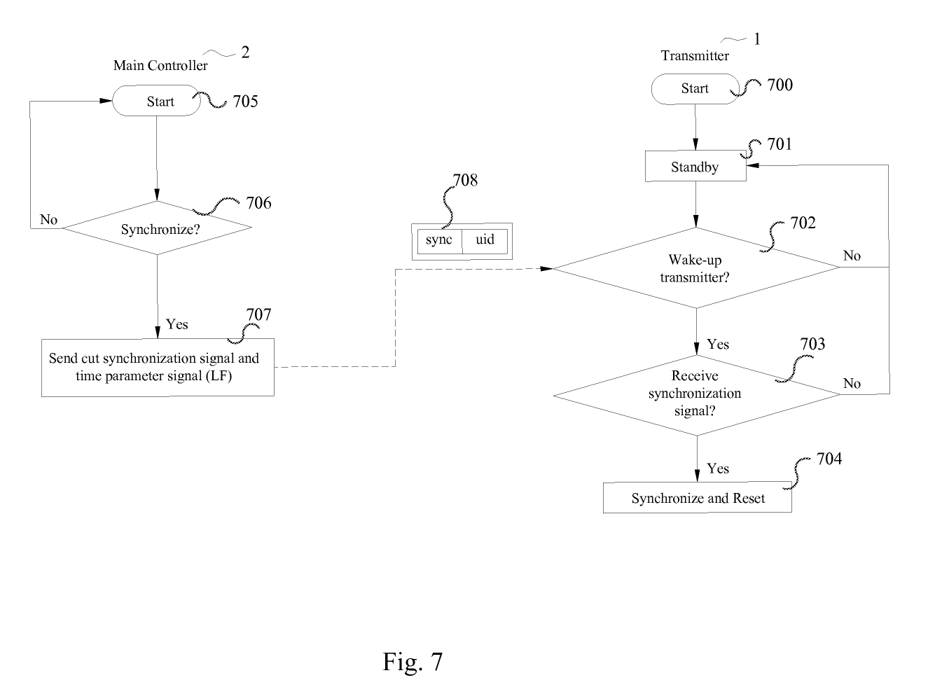

Referring to FIG. 7, the transmitter (1) starts (700) and goes into standby mode (701). If there is no signal to wake up (702) the transmitter (1), it goes back into standby mode (701). If there is a signal to wake up the transmitter (1), it will determine if a synchronization signal is received 703. If a synchronization signal is not received, it goes back to the previous step 702. If a synchronization is received, the transmitter will perform a synchronization and reset 704.

The main controller (2) starts (706) and it will determine if a synchronization is needed 706. If a synchronization is not needed, it will go back to the previous step 705. If a synchronization is needed 707, it will send out a synchronization signal and time parameter signal (708) to the transmitter (1).

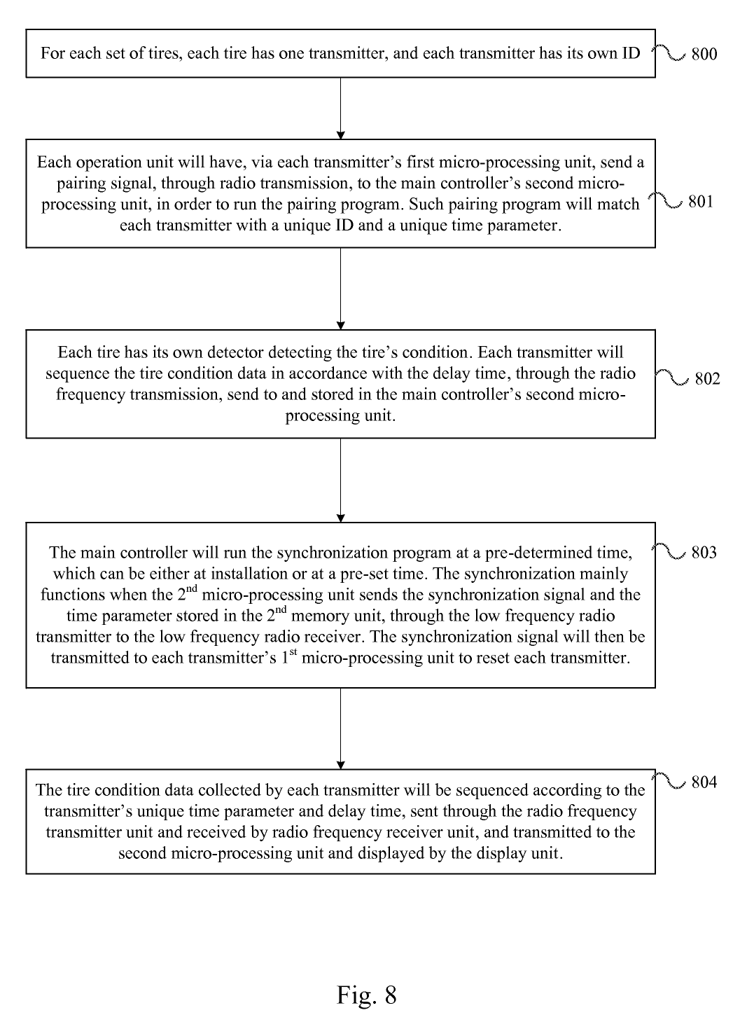

Further, please refer to FIG. 7 and FIG. 8, in accordance with FIG. 2. Method and System for Tire Pressure Monitoring System (TPMS) with Time Encoded Wireless Tire Condition Sensing Device and Synchronization comprises the following steps:

First 800, for each set of tires, each tire has one transmitter (1), and each transmitter (1) has its own ID.

Second 801, each operation unit (102) will, via each transmitter's (1) first micro-processing unit (101), send a pairing signal, through radio transmission, to the main controller's (2) second micro-processing unit (201), in order to run the pairing program. Such pairing program will match each transmitter (1) with a unique ID and a unique time parameter.

Third 802, each tire has its own detector (103) detecting the tire's condition. Each transmitter (1) will sequence the tire condition data in accordance with the delay time, through the radio frequency transmission, send to and stored in the main controller's (2) second micro-processing unit (201).

Fourth 803, the main controller (2) will run the synchronization program at a pre-determined time. The predetermined time can be either at installation or at a pre-set time during the program. The synchronization program mainly function when the second micro-processing unit (201) sends a synchronization signal, along with the time parameter stored in the second memory unit (2011), which is sent through the low frequency radio transmitter (203) and received by the low frequency radio receiver (105). The synchronization signal will then be transmitted to each transmitter's (1) first micro-processing unit (101) to reset each transmitter (1).

Finally 804, the tire condition data collected by each transmitter (1) will be sequenced according to the transmitter's (1) unique time parameter and delay time, sent through the radio frequency transmitter unit (104) and received by radio frequency receiver unit (202), and transmitted to the second micro-processing unit (201) and displayed on the display unit (205).

Further, after vehicles have ran for a period of time, each transmitter may incur error due to its own inconsistency with their clock rate or clock frequency, and it will result in launch time overlap. Therefore, the synchronization program described above will send a synchronizing signal from the main controller (2) and they will be received by each transmitter (1) at the same time. As a result, all the transmitters (1) can shut down at the same time to save battery. As described above, after resetting the transmitter (1), each transmitter (1) will send the collected tire condition data, according to the designated time parameter and delay time, through the radio frequency transmitter unit (104) and the radio frequency receiver unit (202), to the second micro-processing unit (201) and be displayed on the display unit (205). These can effectively avoid the launch time overlap problem due to transmitter's inconsistent clock rate or clock frequency. As a result, the main controller can receive each transmitter's data accurately.

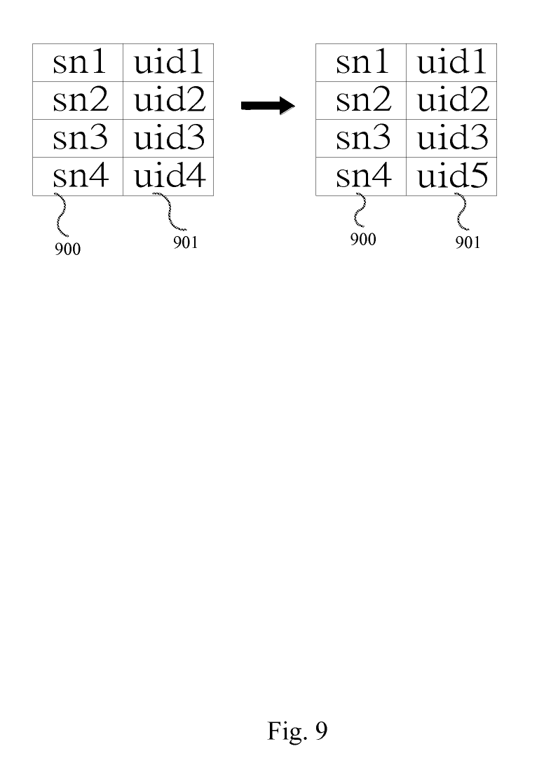

Further, referring to the FIG. 9, along with FIG. 2 and FIG. 5 for supplement, to replace old transmitter (1), press the button on the new transmitter (1), and the new transmitter (1) of the first micro-processing unit (101) sends a pairing signal. The pairing signal is sent by the radio frequency transmitter unit (104), and the main controller's (2) radio frequency receiver unit (202) receives the signal. The main controller (2) of the second micro-processing unit (201) will replace the time parameters to the new transmitter (1), and the timing parameters will be sent through low-frequency transmission unit (203) and received by the new transmitter's (1) low-frequency radio receiving unit (105). The time parameter will be stored in the new transmitter's (1) first memory unit (1011), and the time pairing process has been completed. Accordingly, it is a relatively simple and quick operation to replace old transmitters (1) or to achieve pairing. For example, in FIG. 9, each sensor (900) has a unique ID (901). Originally, sensor 4 had a ID 4, and it can be to replace from ID 4 to ID 5 (901)

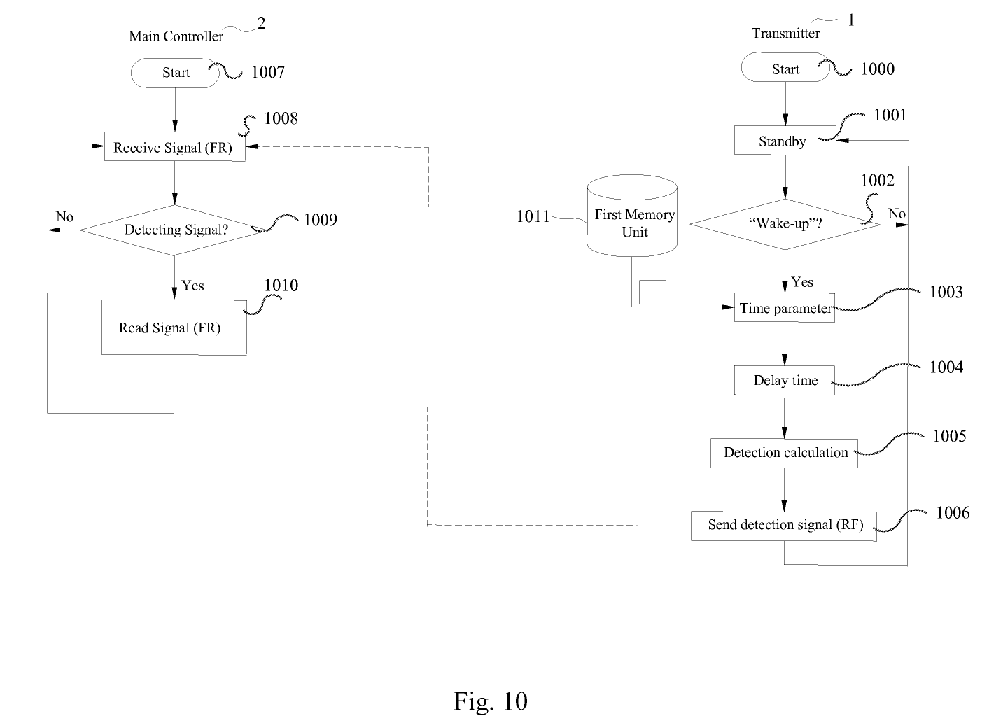

Referring to FIG. 10, the transmitter (1) is started (1000) and goes into standby (1001). If there is no wake-up signal (1002) the transmitter (1) stays in standby (1001). If there is a wake-up signal (1002), then a time parameter is set (1003) and it is stored in the first memory unit (1011). There is a time delay (1009) and then a detection calculation (1005). Then, the transmitter (1) sends a detection signal (1006) to the main controller (2).

The main controller (2) starts (1007) and receives a signal (1008). If the main controller (2) does not receive a detection signal, the main controller (2) goes back to receiving signal status. If there is a signal (1009), then the main controller reads the signal (1010).

Still referring to FIG. 10, when the car is running, each transmitter (1) will periodically wakes from the power-saving state. When the transmitter (1) wakes up, the transmitter (1) will be read from the storage in the first memory unit (1011) that corresponds to the timing parameters and the delay time, and delay the time accordingly. Furthermore, the detection signal is sent by the transmitter system (1) of the radio frequency transmitter unit (104) (as shown in FIG. 2) and transmitted to the main controller's (2) radio frequency receiver unit (202 (as shown in FIG. 2). Then, the main controller (2) of the second micro processing unit (201) (as shown in FIG. 2) interprets the detection signal for tire information, and sends the tire information to the master controller (2) for display by the display unit (205) (as shown in FIG. 2) for the driver to view.

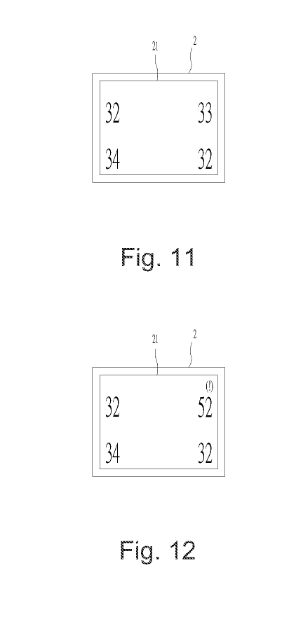

Referring to FIGS. 11 and 12, when the car is started, the main controller's (2) display unit in the car can display the tire condition data of the first transmitter (11) in front wheel of the right hand side (as shown in FIG. 1), the tire condition data detected from the second transmitter (12) of the front wheel of the left hand side (as shown in FIG. 1), the tire condition data gathered from the third transmitter (13) (as shown in FIG. 1) from the rear wheel of the right hand side, and the tire condition data from the fourth transmitter (14) (as shown in FIG. 1) of the rear wheel of the left hand side. In the present embodiment, the screen (21) shows the tire pressure values based 33, 32, 32, 34 respectively. When the screen (21) information corresponding to the value seen in the right front of the vehicle 52 is changed, it means that the right front wheel of the car is abnormal. At this point , the driver should immediately take safety measurement according to the data displayed in the screen (21) to further ensure safe driving.

General description of the above-described embodiments, when fully understood the effect of the operation of the present invention to produce, and the use of the present invention. Provided that the above-described preferred embodiments of the present invention only based embodiment of the present invention is not limited to the embodiment thus the scope of actual application. That is in accordance with the present patent scope and content of the invention described by simple equivalent change and modification, all fall within the scope of the invention covered.

1. A method for monitoring tire pressure comprising
a. providing a main controller wherein said main controller is comprised of a second micro processing unit, a second memory unit, a first receiver unit , a second transmitting unit, a display unit;
b. providing one or more tire transmitter wherein said tire transmitter is comprised of a first micro processing unit, a first memory unit, an operation unit, a detection unit, a first transmitter unit and a second receiving unit;
c. having said first micro processing unit transmit a pairing signal via said first transmitting unit to said second micro processing unit via said first receiver unit;
d. performing a matching process on said pairing signal wherein said matching process is comprised of assigning a first time interval to said pairing signal;
e. storing said pairing signal to said second memory unit;
f. transmitting said pairing signal back to said first micro processing unit via said second transmitting unit and said second receiver unit and storing said pairing signal to said first memory unit;
g. obtaining at least one data point of a tire by said detection unit;
h. transmitting said data point by said first micro processing unit via said first transmitting unit to said second micro processing unit via said first receiver unit at said first time interval;
i. synchronizing said main controller and said one or more tire transmitter comprising said second micro processing unit sending a synchronizing signal via said second transmitting unit and said second receiving unit to said first micro processing unit.

2. The method of claim 2 wherein said first micro processing unit transmits a pairing signal to said second micro processing unit and perform said matching service after receiving said synchronizing signal.

3. The method of claim 3 wherein said matching process is comprised of assigning a second time interval.

4. The method of claim 2 wherein after receiving said synchronizing signal said first micro processor proceeds to obtain at least one data point of said tire by said detection unit and transmit said data point by said first micro processing unit via said first transmitting unit to said second micro processing unit via said first receiver unit at said first time interval.

5. The method of claim 1 wherein said first transmitter unit, said first receiver unit, said second transmitter unit and said second receiver unit are comprised of radio frequency technology.

6. The method of claim 1 wherein said first radio transmitter unit is a low frequency transmitter unit and said second radio receiver unit is a high frequency radio receiver unit.

7. The method of claim 1 wherein said first radio receiver unit is a low frequency receiver unit and said second radio transmitter unit is a high frequency radio transmitter unit.

8. The method of claim 1 wherein said first radio transmitter unit is a high frequency transmitter unit and said second radio receiver unit is a low frequency radio receiver unit.

9. The method of claim 1 wherein said first radio receiver unit is a high frequency receiver unit and said second radio transmitter unit is a low frequency radio transmitter unit.

10. The method of claim 1 wherein said first transmitter unit, said first receiver unit, said second transmitter unit and said second receiver unit are comprised of infra red communication technology.

11. The method of claim 1 wherein said first transmitter unit, said first receiver unit, said second transmitter unit and said second receiver unit are comprised of bluetooth communication technology.

12. The method of claim 1 wherein said paring signal is comprised of an identification code to identify said transmitter.
